(19) United States
(12) Patent Application Publication
(10) Pub. No.: US 2019/0163658 A1
(43) Pub. Date: May 30, 2019

(54) MASTER AND SLAVE, AND IDENTIFICATION NUMBER SETTING APPARATUS

(71) Applicant: ROBOTIS CO., LTD., Seoul (KR)

(72) Inventors: Dae Sung CHOI, Bucheon-si, Gyeonggi-do (KR); Soo Kyung SON, Gimpo-si, Gyeonggi-do (KR); Hee Il KIM, Suwon-si, Gyeonggi-do (KR); Byoung Soo KIM, Seoul (KR)

(73) Assignee: ROBOTIS CO., LTD., Seoul (KR)

(21) Appl. No.: 15/737,314

(22) PCT Filed: Nov. 24, 2017
(86) PCT No.: PCT/KR2017/013530

§ 371 Date: May 16, 2018

(51) Int. Cl. G06F 13/362; G06F 7/58

(52) U.S. Cl. CPC G06F 13/362; G06F 7/588

(57) ABSTRACT

Disclosed is a slave device including an identification number setting operation sensor sensing a user's operation for performing an identification number setting operation on the slave device, a slave controller connected to the identification number setting operation sensor, and a storage unit connected to the slave controller and storing an identification number corresponding to a state range, wherein, when an identification number setting command packet is transmitted from a master device, the slave controller determines a state determined according to the user's identification number setting operation using a signal from the identification number setting operation sensor and determines an identification number corresponding to the state in the storage unit, as an identification number of the slave device.

### TECHNICAL FIELD

The present invention relates to a master device, a slave device, and an identification number setting apparatus including the master device and the slave device, and more particularly, to a master device and a slave device connected to each other according to a multi-drop communication scheme, the master device setting an identification number of the slave device, and an identification number setting apparatus including the master device and the slave device.

### BACKGROUND ART

A recent multi-drop communication scheme is performed to perform communication such that at least one slave, i.e., at least one slave device, responds to a request from a master, i.e., a master device, based on an identification number (ID).

Here, all the slaves connected to the master must have a unique identification number and the identification numbers of all the slaves must be different from each other so that the master may designate a desired specific slave among the plurality of slaves using the identification numbers of the slaves.

If a plurality of slaves having the same identification number are present, the plurality of slaves having the same identification number may respond to a request from the master, causing a signal distortion phenomenon, and the master cannot accurately distinguish between the slaves and cannot normally control each of the slaves having the same identification number.

Thus, in the related art, a dedicated apparatus for setting an identification number using a dip switch or a rotary switch is provided, but, in this case, a problem in terms of space for installing the dedicated apparatus for setting an identification number and a problem of installation cost arise.

In addition, the dedicated apparatus for setting an identification number must be electrically connected to a corresponding slave to which an identification number is to be assigned. Here, however, in case where a plurality of control modules or driving devices (or actuators) serving as slaves are connected to each other by electrical wiring, or the like, so as to be assembled, a portion or the entirety of the assembled configuration must be disassembled, which is troublesome.

Also, when slaves operate as driving devices for individually controlling many parts such as in a robot, a unique identification number must be assigned to each slave before a plurality of parts including a plurality of driving devices are assembled. However, when an identification number which has been repeatedly assigned is found after assembling is completed, the assembled product must be disassembled, resulting in a great amount of time and trouble.

### RELATED ART DOCUMENT

### Patent Document

Patent document 1: Korean Laid-Open Publication No. 10-2012-0121681 (Publication date: Nov. 6, 2012, Title: Apparatus and Method for Checking ID of Servo)

Patent document 2: Korean Laid-Open Publication No. 10-2005-0043194 (Publication date: May 11, 2005, Title: Communication Method between Digital Home Appliances)

### DISCLOSURE

### Technical Problem

The aspect of the present invention is to easily and accurately assign an identification number of a slave device to enhance user convenience.

Another aspect of the present invention is to assign an identification number of a desired portion, without changing a state in which a corresponding product is completely assembled, further enhancing user convenience.

### Technical Solution

According to an aspect of the present invention, there is provided a slave device including: an identification number setting operation sensor sensing a user's operation for performing an identification number setting operation on the slave device; a slave controller connected to the identification number setting operation sensor; and a storage unit connected to the slave controller and storing an identification number corresponding to a state range, wherein, when an identification number setting command packet is transmitted from a master device, the slave controller determines a state determined according to the user's identification number setting operation using a signal from the identification number setting operation sensor and determines an identification number corresponding to the state in the storage unit, as an identification number of the slave device.

The identification number setting operation sensor may be an angle sensor sensing an angle of the slave device according to the user's identification number setting operation, and the slave controller may select an identification number in the storage unit using a sensing signal (or detection signal) output from the angle sensor and determine the selected identification number as an identification number of the slave device.

The identification number setting operation sensor may be a bending sensor sensing a bending state of the slave device according to the user's identification number setting operation, and the slave controller may select an identification number in the storage unit using a sensing signal output from the bending sensor and determine the selected identification number as an identification number of the slave device.

The identification number setting operation sensor may be a position sensor sensing a bending state of the slave device according to the user's identification number setting operation, and the slave controller may select an identification number in the storage unit using a sensing signal output from the position sensor and determine the selected identification number as an identification number of the slave device.

The slave device may further include: a random number generator connected to the slave controller, wherein the slave controller determines a random number generated by the random number generator using the identification number setting operation sensor, as an identification number of the slave device.

The slave device may further include: a state notification unit connected to the slave controller and operated by the slave controller when the identification number setting command packet is transmitted.

According to another aspect of the present invention, there is provided an identification number setting apparatus including a master device and a plurality of slave devices connected to a bus according to a multi-drop communication scheme, wherein when the master device transmits an identification number setting command packet to the plurality of slave devices, a slave device in which an identification number is first set may set an identification number according to a first setting operation and transmit the set identification number to the bus, and the other remaining slave devices, excluding the slave device which has first transmitted the identification number, among the plurality of slave devices, each set a value, which does not overlap identification numbers of the other slave devices previously received through the bus, as its identification number according to second setting operations sequentially input to the other remaining slave devices, and transmit the set identification number to the bus.

The other remaining slave devices, excluding the slave device which has first transmitted the identification number, among the plurality of slave devices, may each set a result value obtained by adding a predetermined value to an identification number of a slave device which has set an identification number immediately previously according to second setting operations sequentially input to the other remaining slave devices, as its identification number, and transmit the set identification number to the bus.

### Advantageous Effects

According to the features, even in case where an identification number setting operation is performed on each slave device and the same identification numbers are present in a state in which the master device and the plurality of slave devices are completely assembled to a corresponding apparatus, the identification number setting operation may be performed again without having to disassembling at least a portion of the corresponding apparatus, reducing time for setting identification numbers.

Further, since a separate apparatus dedicated for setting an identification number is unnecessary and the identification number setting operation is performed easily, the operation for setting identification numbers may be easily and quickly performed.

Furthermore, since the identification number setting operation is performed as the user operates a portion related to each slave device in a determined state, user convenience setting an identification number may be improved.

### DESCRIPTION OF DRAWINGS

FIG. 1 is a block diagram of an identification number setting apparatus for setting an identification number to a driving control module according to an embodiment of the present invention.

FIG. 2 is a schematic block diagram of a central control module illustrated in FIG. 1.

FIG. 3 is a schematic block diagram of the driving control module illustrated in FIG. 1.

FIGS. 4A to 8B are data flowcharts according to various examples of an identification number setting apparatus for setting an identification number to a driving control module according to an embodiment of the present invention.

FIG. 9 is a schematic block diagram of a driving control module of an identification number setting apparatus according to another embodiment of the present invention.

FIG. 10 is a data flowchart of an identification number setting apparatus according to another embodiment of the present invention.

### BEST MODES

Hereinafter, embodiments of the present invention will be described in detail with reference to the accompanying drawings. In describing the present invention, if it is determined that a detailed description of known functions and components associated with the present invention unnecessarily obscure the gist of the present invention, the detailed description thereof will be omitted.

The terms used henceforth are used to appropriately express the embodiments of the present invention and may be altered according to a person of a related field or conventional practice. Therefore, the terms should be defined on the basis of the entire content of this specification.

Technical terms used in the present specification are used only in order to describe specific exemplary embodiments rather than limiting the present invention. The terms of a singular form may include plural forms unless referred to the contrary. It will be further understood that the terms “comprise” and/or “comprising,” when used herein, specify the presence of stated features, integers, steps, operations, elements, and/or components, but do not preclude the presence or addition of one or more other features, regions, integers, steps, operations, elements, components, and/or groups thereof.

Hereinafter, a master device, a slave device, and an identification number setting apparatus including the master device and the slave device according to an embodiment of the present invention will be described with reference to the accompanying drawings.

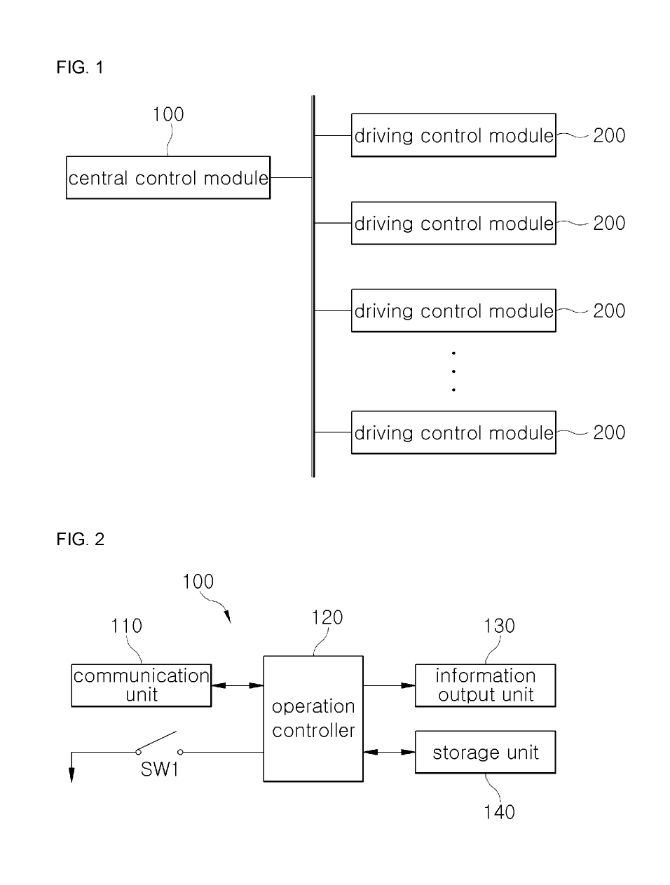

First, the identification number setting apparatus for setting an identification number to a driving control module serving as a slave device according to the present embodiment will be described with reference to FIG. 1.

As illustrated in FIG. 1, the identification number setting apparatus includes a central control module 100 and a plurality of driving control modules 200 connected to the central control module 100 via a network.

The central control module 100 controls an operation of the plurality of driving control modules 200 connected via the network.

For example, in a driving device having a plurality of driving modules (actuators) having a driving unit like a robot system such as a cleaning robot, a toy robot, and the like, a control module for comprehensively controlling an operation of the plurality of driving modules is a central control module and each driving module substantially controlling an operation of the corresponding driving unit under the control of the central control module is a driving control module.

Accordingly, the robot system includes the central control module 100 and the plurality of driving control modules 200, and the central control module 100 and the plurality of driving control modules 200 are assembled together with other components to form the robot system.

Here, the central control module serves as a master device, and each driving control module serves as a slave device controlled in operation by the master device.

In this example, as a network between the central control module 100 and each of the driving control modules 200, a physical network in which a plurality of terminals are connected to a single node according to a multi-drop communication scheme is applied, and the multi-drop communication scheme may be, for example, a controller area network (CAN), an RS-485, Ethernet, and the like.

The central control module 100 includes a communication unit 110 for communicating with the plurality of driving control modules 200, an operation controller (e.g., a master controller) 120 connected to the communication unit 110, an information output unit 130 connected to the operation controller 120, and a storage unit 140 connected to the operation controller 120.

The communication unit 110 is a transmission/reception port for transmitting and receiving data and commands, and may be, for example, a communication port for serial communication with the plurality of the driving control modules 200.

The operation controller 120, a controller that controls an overall operation of the central control module 100, controls an operation of setting identification numbers of the plurality of driving control modules 200 connected to a single common bus so that the identification numbers of the respective driving control modules 200 may be set to be different.

The information output unit 130 displays an image corresponding to image data output from the operation controller 120 on a screen under the control of the operation controller 120 such that the corresponding information or state is visually output to the user.

The information output unit 130 may be a liquid crystal display (LCD), an organic light emitting display (OLED), a flexible display, or the like.

The storage unit 140 is a storage medium in which data and commands necessary for an operation of the central control module 100 and data and commands generated during and operation are controlled. The storage unit 140 may be a memory.

The components 110 to 140 of the central control module 100 illustrated in FIG. 2 are not essential so that the central control module 100 may further include at least one component in addition to the components 110 to 140 or at least one of the components 110 to 140 may be omitted.

For example, the plurality of driving control modules 200 may be control modules operating a driving device (actuator) such as a motor which operates according to a control signal from the central control module to move each part of a robot system to a corresponding state.

The driving control module 200 includes a sensor unit 210, a communication unit 220, a driving controller (e.g., a slave controller) 230 connected to the sensor unit 210 and the communication unit 220, a state notification unit 240 connected to the driving controller 230, a driving unit 250 connected to the driving controller 230, and a storage unit 260 connected to the driving controller 230.

The sensor unit 210 senses a state of the driving control module 200 and outputs a sensing signal indicating the corresponding state of the driving control module 200. The sensor unit 210 includes an angle sensor 211 senses a current angle, i.e., a current rotation angle, of the driving control module 200 and outputting a sensing signal of the corresponding state, a voltage sensor 212 and a current sensor 213 respectively sensing a voltage and a current of the driving unit 250, and a temperature sensor 214 sensing an internal temperature of the corresponding driving control module 200.

Therefore, the driving controller 230 determines a rotation angle of the driving control module 200 to which the driving controller 230 belongs, magnitudes of a present current and voltage of the corresponding driving unit, an internal temperature, and the like, using the sensing signal applied from the sensor unit 210.

Here, the angle sensor 211 may be an incremental-type sensor using a hall sensor, or the like, or a sensor using an absolute encoder or a change in variable resistance. Also, when an identification number setting operation is performed on the corresponding driving control module 200 by the user, the angle sensor 211 may serve as an identification number setting operation sensor sensing the user's identification number setting operation.

Here, in an alternative example, instead of or in addition to the angle sensor 211, an angular velocity sensor that senses an angular velocity may serve as an identification number setting operation sensor that senses a user's identification number setting operation.

The communication unit 220, a communication port for performing communication with the central control module 100, may be a serial communication port as described above.

The driving controller 230 controls an overall operation of the driving control module 200 and, in particular, the driving controller 230 controls an operation of the driving unit 250 under the control of the central control module 100.

The driving controller 230 of the present embodiment determines a state of the identification number setting operation performed according to a user's operation, determines an identification number of the driving control module 200 determined by the user, 100 and informs the identification number to the central control module 100 or informs the central control module 100 that an identification number setting operation has been performed on the corresponding driving control module so that the identification number setting operation may be performed by the central control module 100.

The state notification unit 240 changed in an operational state under the control of the driving controller 230 informs the user that an operational state of the current driving control module 200 is an operational state for setting an identification number. Accordingly, the user performs an operation for setting an identification number for the driving control module 200 in which the state notification unit 240 is operated.

The state notification unit 240 may include a light emitting unit such as a light emitting diode (LED), a buzzer, or the like.

The driving unit 250 operates under the control of the driving controller 230 and controls an operation of a portion related to the corresponding driving control module 200, i.e., a portion (e.g., a wrist joint portion of the robot, an elbow joint portion, an ankle joint portion, a knee joint portion, a shoulder joint portion, a neck joint portion, etc.) on which an operation is performed under the control of the corresponding driving control module 200.

The driving unit 250 may include, for example, a motor 252 and a motor driver 251 that operates according to a control signal of the driving controller 230 to control an operational state of the motor 252. Here, the motor 252 may be various types of motor such as a servo motor, a DC motor, a linear motor, and the like.

The storage unit 260 is a storage medium such as a memory for storing data and commands for an operation of the driving control module 200 and controlling data and commands generated during an operation.

In addition, in the storage unit 260, an identification number corresponding to an operational state (e.g., a size of an operation angle with respect to a corresponding portion or the number of bending of the corresponding portion, etc.) for setting an identification number for each driving control module 200 may be stored in a lookup table, or the like.

That is, the storage unit 260 has a plurality of divided state ranges, and one identification number corresponding to each of the divided state ranges is stored in the storage unit 260. Accordingly, here, the divided state ranges are ranges of values (e.g., a size of a rotation angle, the number of bending, a movement distance (e.g., a location), etc.) determined by a sensing signal output from the identification number setting operation sensor according to an operational state of the user.

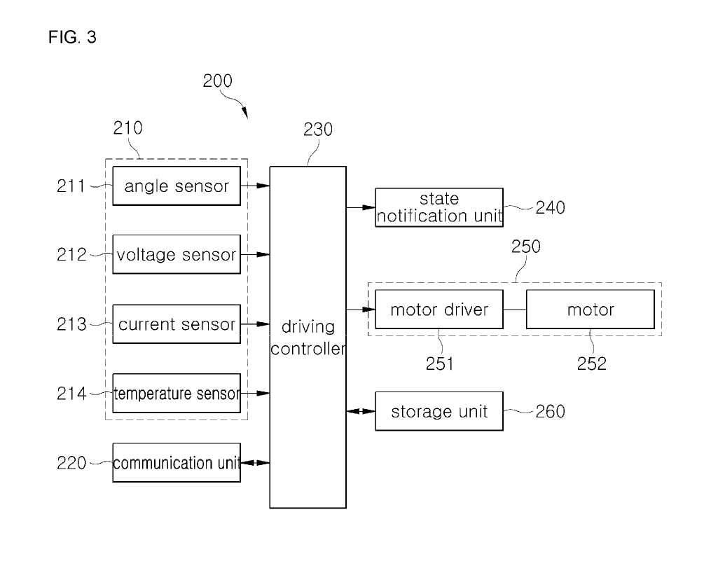

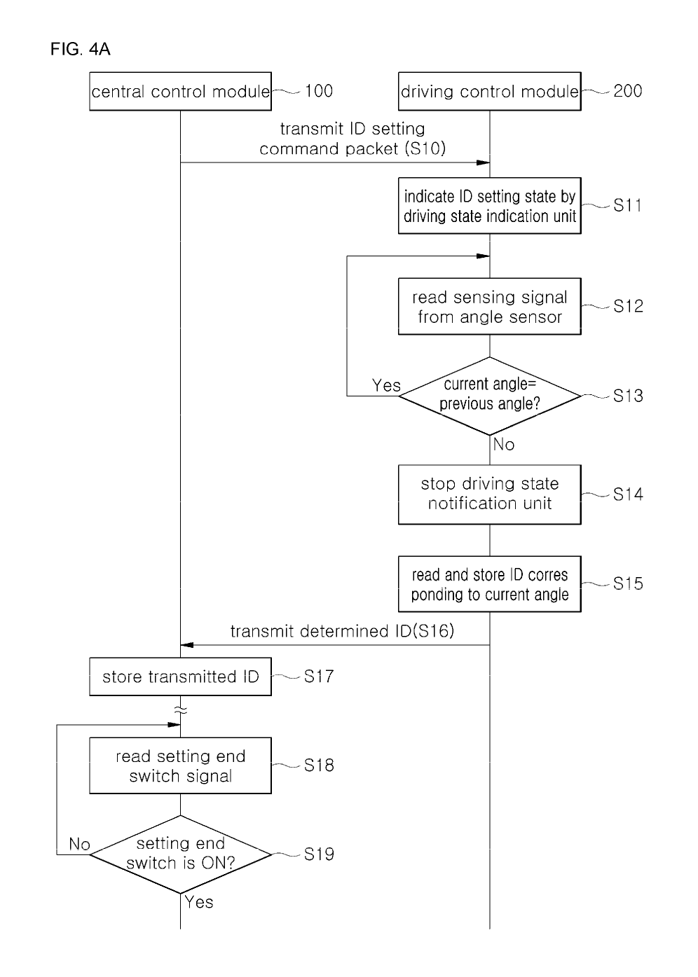

The components 210 to 260 of each driving control module 200 illustrated in FIG. 3 are not essential and the driving control module 200 may further have at least one component other than the components 210 to 260 or at least one of the components 210 to 260 may be omitted.

An identification number setting method of the identification number setting apparatus having such a structure will be described.

Since identification number setting operations of the plurality of driving control modules 200 connected to one central control module 100 in a multi-drop communication manner are all the same, the operation of one driving control module 200 will be described. The plurality of driving control modules 200 may be manufactured to have the same identification number or without an identification number.

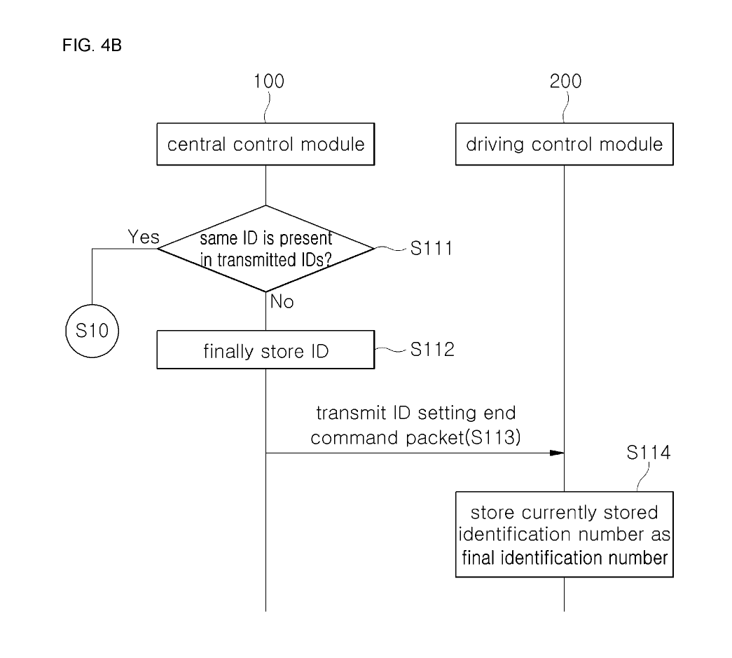

First, an example of a method of setting an identification number regarding an identification number setting apparatus according to the present embodiment will be described with reference to FIGS. 4A and 4B.

When power required for operations of the central control module 100 and the driving control module 200 is supplied by a power supply unit (not shown) and the central control module 100 and the driving control module 200 start to operate, the operation of the central control module 100 proceeds to a routine for setting an identification number (ID) of the plurality of driving control modules 200 connected to the same bus.

To this end, first, the operation controller 120 of the central control module 100 transmits, to the driving control module 200 connected to the central control module 100, an identification number setting command packet (i.e., an ID setting command packet) using the communication unit 110 (S10).

Thus, when the identification number setting command packet is transmitted from the central control module 100 (S10), the driving control module 200 operates the state notification unit 240 to inform the user that a current operation state is an identification number setting operation state.

When the state notification unit 240 of each of the driving control modules 201 to 203 operates, the user performs an operation to set an identification number of the driving control module 200 in which the state notification unit 240 operates.

To this end, for example, the user operates a portion where each driving control module 200 is seated (e.g., a wrist joint portion, an elbow joint portion, etc.) by a predetermined angle.

Here, an identification number to be set in the corresponding driving control module 200 and an operation angle (e.g., rotation angle) corresponding thereof have already been determined, and the user also knows the identification number to be set for the corresponding driving control module 200 and the operation angle determined according to the identification number. Thus, the user operates the corresponding portion by the angle corresponding to the identification number for each driving control module 200.

For example, when an overall operation angle range is 0 to 360 degrees and the number of driving control modules 200 is 8, an identification number of each driving control module 200 and an operation angle range corresponding thereto may be as illustrated in Table 1 below.

TABLE 1

| | Identification | Operation angle range |
|---|---|---|
| Driving control module type | number | (degree) |
| First driving control module | 1 | 0°~45° |
| Second driving control | 2 | 46°~90° |
| module | | |
| Third driving control module | 3 | 91°~135° |
| Fourth driving control module | 4 | 136°~180° |
| Fifth driving control module | 5 | 181°~125° |
| Sixth driving control module | 6 | 126°~270° |
| Seventh driving control | 7 | 271°~315° |
| module | | |
| Eighth driving control module | 8 | 316°~360° |

Accordingly, in the case of Table 1, when the identification number of the first driving control module should be “1”, the user operates a corresponding portion within the angle range of 0 to 45. That is, in a situation where the identification number of the first driving control module is “1”, an angle sensed by the angle sensor is within the range of 0 to 45 degrees.

In this manner, when the first to third driving control modules 200, three driving control modules, are connected to the single central control module 100, a size of each of the operation angle ranges of each driving control module 200 may be 120°, and thus, an operation angle range of the first driving control module 200 may be 0°˜120°, an operation angle range of the second driving control module 200 may be 121°˜240°, and an operation angle range of the third driving control module 200 may be 241°˜360°. Here, the identification number of the first driving control module may be ‘4’, the identification number of the second driving control module may be ‘5’, and the identification number of the third driving control module may be ‘6’.

Therefore, the user performs the identification number setting operation by operating the corresponding portion related to each driving control module 200 by an angle corresponding to the operation angle range corresponding to each identification number.

Meanwhile, the overall operation angle range is not limited to 0° to 360° and may be varied according to the number of driving control modules. Therefore, the overall operation angle range may also be defined as a range exceeding 360°.

For example, when the overall operation angle range is defined as 0° to 720° and the overall operation angle range is divided equally into four sections, a size of an operation angle range corresponding to one identification number amounts to 180°. That is, the identification number is switched at a point in which an axis of a motor rotates by half a wheel.

In this manner, when the overall operation angle range is increased, accurate identification numbers may be set even when the number of driving control modules connected to one bus is large, without an excessively precise operation.

Accordingly, after the driving controller 230 of each driving control module 200 operates the state notification unit 240 (S11), the driving controller 230 of each driving control module 200 reads a signal applied from the angle sensor 211 to determine a current angle, i.e., a current rotation angle, of the corresponding driving control module 200, i.e., a rotation angle of a portion related to the corresponding driving control module and stores the determined rotation angle in the storage unit 260 (S12).

Thereafter, the driving controller 230 of the driving control module 200 compares the determined current angle with a previous angle of a previous step and determines whether the current angle and the previous angle are equal to each other (S13).

Here, it is assumed that, among the first to third driving control modules 200 as the three driving control modules, the first driving control module 200, one driving control module, is in a state in which an angle of the corresponding portion is adjusted to set an identification number, that is, in a state in which an identification number setting operation is performed by the user, and the other second and third driving control modules are in a state in which an angle is not adjusted by the user to set an identification number, that is, in a state in which the identification number setting operation is not performed by the user.

Thus, in case where the current angle and the previous angle are equal, the corresponding driving controller determines that an angle of the corresponding portion has not been adjusted yet by the user, that is, that an angle of the corresponding portion has not been adjusted yet to set an identification number.

Thus, the driving controller 230 of the corresponding driving control module 200, while maintaining the driving state of the state notification unit 240, proceeds to step S12 to read sensing signals output from the angle sensor 211. Accordingly, the user recognizes that the operation of setting the identification numbers of the second and third driving control modules 200 has not been performed using the operating state notification unit 240.

However, in the case of the first driving control module 200 in which the identification number setting operation is currently performed, the current angle currently determined by the angle sensor 211 and a previous angle are different from each other (S13). Therefore, the driving controller 230 of the first driving control module 200 determines that the first driving control module 200 is currently being adjusted for setting an identification number by the user, and stops the operation of the state notification unit 240 (S14).

Thereafter, the driving controller 230 of the corresponding driving control module 200 having the current angle different from the previous angle determines an identification number corresponding to the determined current angle and stores the same in the storage unit 260 (S15).

Thereafter, the driving controller 230 of the driving control module 200 transmits the determined identification number to the central control module 100 using the communication unit 22 (S16).

In this case, since the operation angle range for each identification number has been determined in the storage unit 260 of each driving control module 200, the driving controller 230 of each driving control module 200 determines an operation angle range to which the current angle belongs and determines an identification number corresponding to the determined operation angle range.

Accordingly, the central control module 100 stores the current identification number transmitted from the corresponding driving control module, for example, the first driving control module 200, in the storage unit 140 (S17).

When the identification number setting operation is completed by the user by adjusting the angle of the corresponding portion related to the remaining driving control module 200, the user operates a setting end switch SW1 installed in the central control module 100 to inform the operation controller 120 of the central control module 100 about completion of the identification number setting operation.

Therefore, the operation controller 120 of the central control module 100 reads a signal applied from the setting end switch SW1 to determine whether the setting end switch SW1 is operated, that is, turned on (S18 and S19).

When it is determined that the setting end switch SW1 operated by the user is in an ON state, the operation controller 120 determines whether the same identification number is present using the identification number which has been transmitted from each driving control module 200 and stored in the storage unit 140, that is, whether an overlap identification number is present (S110 and S111).

Here, a known method is used to determine the duplication of the identification number in the central control module 100.

If it is determined that the duplicate identification is present (S111), the operation controller 120 determines that a plurality of driving control modules 200 to which the same identification number has been assigned due to a user's mistake in an operation of adjusting an angle are present.

In an alternative example, when the setting end switch SW1 does not exist, the central control module 100 transmits the identification number setting command packet, and thereafter, the central control module 100 determines whether a set time has elapsed. When the set time has elapsed, the central control module 100 may perform an operation of comparing identification numbers transmitted from each driving control module 200.

Therefore, the operation controller 120 proceeds to step S10 and transmits an identification number setting command packet to all the driving controllers 120 to resume the identification number setting operation for all the driving control modules 200. Here, the identification number of each driving control module 200 stored in the storage unit 140 may be deleted by the operation controller 120.

However, if there is no duplicate identification number, that is, if all the driving control modules 200 are given different identification numbers, the operation controller 120 determines that identification numbers have been normally given to all the driving control modules 200 and stores the identification numbers stored in the storage unit 140 as final identification numbers (S112). Here, the operation controller 120 of the central control module 100 may output a final identification number to the information output unit 130 to inform the user of the identification number set in the driving control module 200.

Thereafter, the controller 120 transmits an identification number setting end command packet (i.e., an ID setting end command packet) to each driving control module 200 (S113) to inform each driving control module 200 that the identification number setting operation is completed.

Therefore, the driving controller 230 of the driving control module 200 stores the current identification number stored in the storage unit 260 as its final identification number, and then ends the identification number setting operation (S114).

In a state in which the central control module 100 and the plurality of driving control modules 200 are completely assembled in a corresponding driving device (e.g., a robot system) according to the identification number setting operation, the identification number setting operation is performed on each driving control module 200, and if an overlap identification number is present, the identification number setting operation is performed without disassembling at least a portion of the driving device.

Therefore, an operation time for giving the identification number of each driving control module 200 may be significantly reduced.

When the identification number setting command packet is transmitted from the central control module 100, the driving controller 230 of each driving control module 200 determines an operational state performed by the user using a sensing signal from the angle sensor 211 as an identification number setting operation sensor, that is, an angle according to a movement regarding a corresponding portion by the user, determines an identification number corresponding to a size of the angle determined according to the performed operational state using the identification number stored in the storage unit 260, and determines the same as an identification number of the corresponding driving control module 200.

Accordingly, a separate dedicated apparatus for setting an identification number is not necessary, and the operation for setting the identification number may be easily and quickly performed.

In the case of FIGS. 4A and 4B, when the identification number according to the determined angle is determined, each driving control module 200 transmits its identification number, which is determined independently of a request from the central control module 100, to the central control module 100.

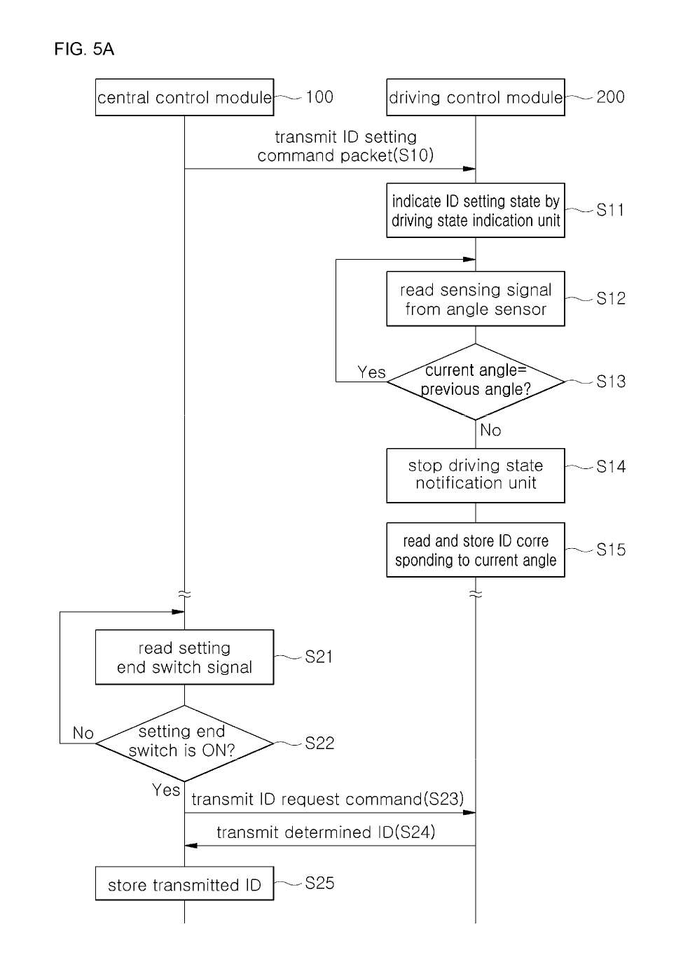

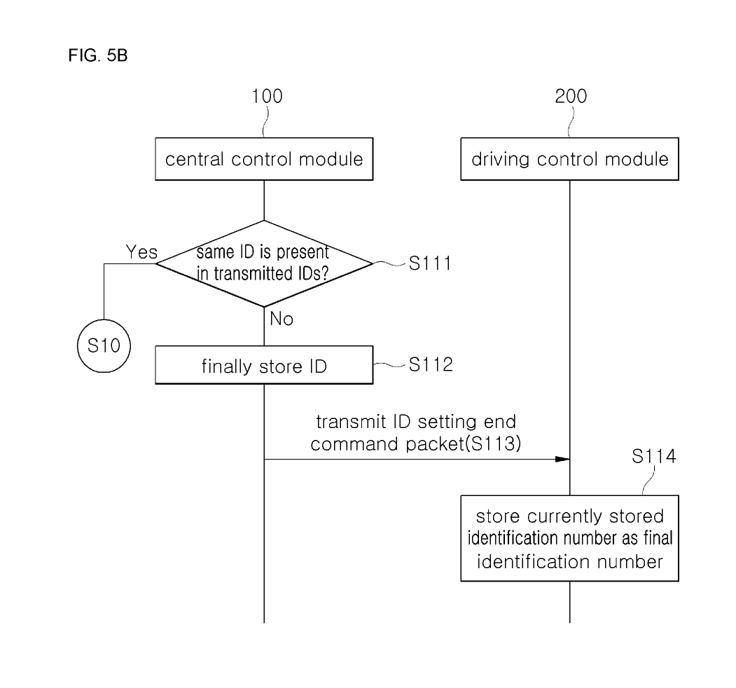

However, the present invention is not limited thereto, and as illustrated in FIGS. 5A and 5B, in another example, each driving control module 200 may transmit its identification number according to a request from the central control module 100.

That is, as set described above with reference to FIG. 4A, when an identification number setting command packet is transmitted from the central control module 100 to each driving control module 200 (S10), each driving control module 200 operates each corresponding portion within an operation angle range to obtain an identification number corresponding to the operation angle and stores the same in the storage unit 260 as described above (S11 to S15).

When the driving control module 200 performs the identification number setting operation, the central control module 100 reads a signal applied from the setting end switch SW1 to determine whether the setting end switch SW1 is turned on by the user (S21 and S22).

When it is determined that the setting end switch SW1 is operated by the user (S22), the operation controller 120 of the central control module 100 transmits an identification number request command to all the driving control modules 200 through the bus (S23).

Accordingly, upon receiving the identification number request command, each driving control module 200 reads the currently determined own identification number stored in the storage unit 260 and sequentially transmits the identification number read through the bus to the central control module 100) (S24).

Here, an identification number transmission timing of each driving control module 200 may be determined according to its identification number.

For example, a delay time may be determined according to a size of the identification number, and after the identification number request command is transmitted from the central control module 100, each driving control module 200 transmits its identification number at a timing after the lapse of the predetermined delay time.

For example, when the identification number is ‘1’, the delay time may be ‘0’, when the identification number is ‘2’, the delay time may be ‘1 ms’, and when the identification number is ‘2’, the delay time may be ‘2 ms’. The delay times corresponding to sizes of identification numbers are already stored in the storage unit 260.

Accordingly, the plurality of driving control modules 200 are prevented from transmitting identification numbers at the same time through the same bus.

In this manner, when the identification numbers are received from all the driving control modules 200 according to the request by the operation controller 120, the operation controller 120 of the central control module 100 stores the identification numbers transmitted from all the driving control modules 200 in the storage unit 140 (S25), determines whether there is an overlap identification number in the identification number transmitted from each driving control module 200 (S111), and when an overlap identification number is present, the operation of setting an identification number of all the driving control module 200 starts again (S10).

However, if all the identification numbers transmitted from all the driving control modules 200 are different from each other, the operation controller 120 of the central control module 100 stores the transmitted identification number regarding each driving control module 200 as a final identification number of each driving control module 200 (S112) and transmits an identification number setting end command packet to all the driving control modules 200 (S113).

Accordingly, each driving control module 200 stores the identification number currently stored in the storage unit 260 according to transmission of the setting end command packet, as its final identification number (S114).

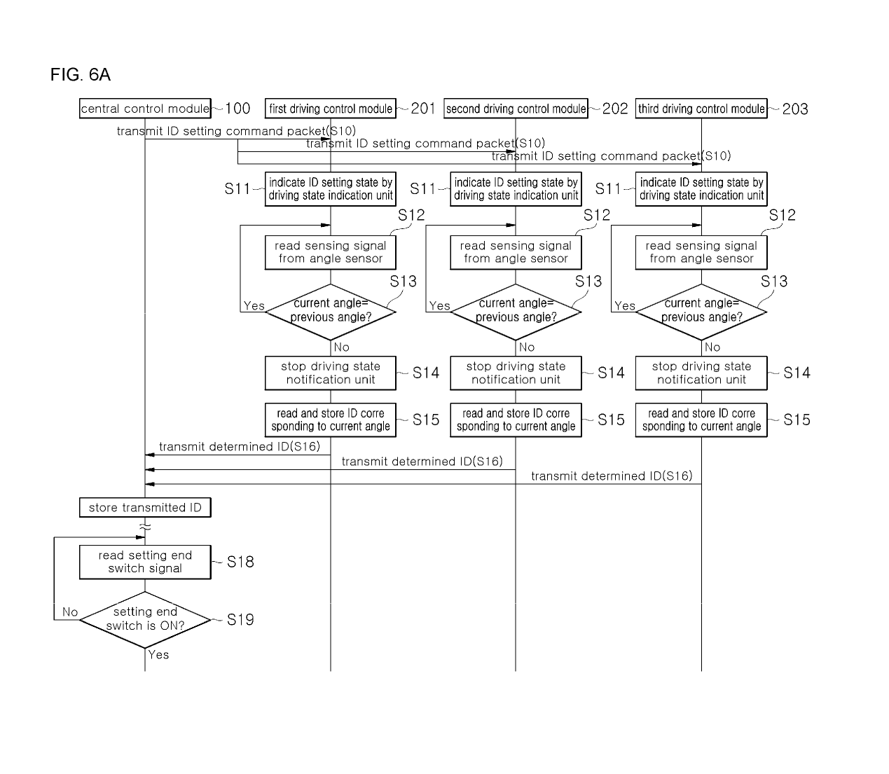

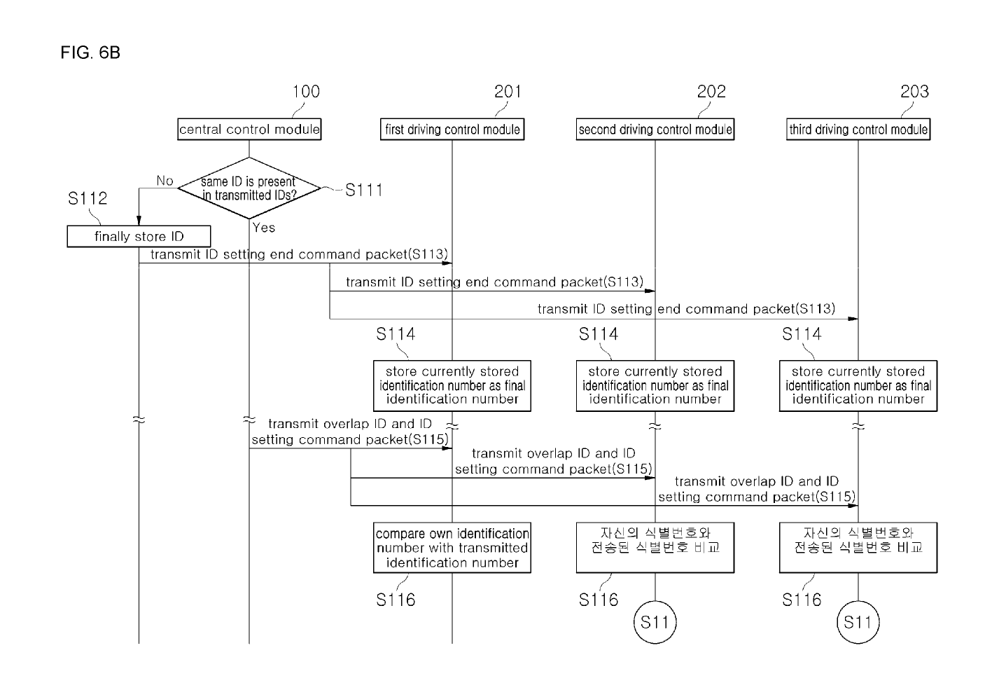

Hereinafter, an identification number setting method according to another example of the present invention will be described with reference to FIGS. 6A and 6B.

Compared with FIGS. 4A and 4B, like the operations in steps S11 to S111 of FIGS. 4A and 4B, when an identification number setting command packet is transmitted to every driving control module 200 from the central control module 100, each driving control module 200 controls an angle of a corresponding portion, obtains a corresponding identification number according to a size of a determined angle, and transmits the obtained identification number to the central control module 100, and when the identification number setting operation regarding every driving control module 200 is completed and the setting end switch SW1 is operated by the user, the central control module 100 compares identification numbers transmitted from all the driving control modules 200 and determines whether the same identification number exists, and when the same identification number exists, the central control module 100 performs the identification number setting operation. This is the same as FIGS. 4A and 4B.

Here, in the identification number setting method of FIGS. 4A and 4B, the central control module 100 transmits an identification number setting command packet to all the driving control modules 200 connected to the central control module 100 and performs an identification number setting operation on all the driving control modules 200.

However, in the case of the example illustrated in FIGS. 6A and 6B, only the driving control module 200 having the same identification number performs the identification number setting operation.

Thus, re-performing the identification number setting operation by the driving control module 200 having the same identification number will be described with reference to FIGS. 6A and 6B.

For the purposes of description, for example, it is assumed that three driving control modules 201 to 203 connected to one bus are connected to one central control module 100 and the identification numbers determined in the second and third driving control modules 202 and 203 are the same. All of the driving control modules 201 to 203 have the same components as those illustrated in FIG. 3, and the initial identification numbers of the driving control modules 201 to 203 are all set to the same value.

Each of the driving control modules 201 to 203 performs the same operation as described above to determine an identification number and then transmits the determined identification number to the central control module 100, so that the identification numbers of the driving control modules 201 to 203 are stored in the storage unit 140 of the central control module 100 (S10 to S17).

Accordingly, when there is no overlap identification number according to a comparison operation of the operation controller 120 of the central control module 100 according to an operation of the setting end switch SW1, the identification number setting end command packet is transmitted to the driving control module 201 to 203 to end the identification number setting operation (S18 to S114).

However, if there are driving control modules (e.g., the second and third driving control modules 202 and 203) having the same identification numbers so overlap identification numbers are present (S111), the operation controller 120 of the central control module 100 may cause the identification setting operation of the driving control modules 202 and 203 having the overlap identification numbers to be performed again.

Accordingly, the central control module 100 transmits an identification number setting command packet along with the overlap identification number to the bus (S115).

The first to third driving control modules 201 to 203, which have received the identification number setting command packet transmitted from the central control module 100, compare the transmitted identification number and the identification number stored in the storage unit 260 to determine whether both identification numbers are the same (S116).

Accordingly, the driving control modules (e.g., the second and third driving control modules 202 and 203) whose identification number is the same as the transmitted identification number proceeds to operation S11 according to the transmitted identification number setting command packet so that the identification number setting operation may be performed by the user.

Meanwhile, the driving control module (for example, the first driving control module 201) whose identification number is different from the transmitted identification number disregards the transmitted identification number setting command packet so that the identification number setting operation may not be performed anew.

As a result, only the corresponding driving control modules 202 and 203 having the overlap identification numbers perform the identification number setting operation again. Here, in case where the driving control modules 202 and 203 have an information output unit for outputting information, the identification numbers transmitted from the central control module 100 may be output, and thus, the identification numbers set in the corresponding driving control modules 202 and 203 may be checked so that a more accurate identification number setting operation may be performed. In this case, since the overlap identification number setting operation for the driving control module 200 is omitted, unnecessary power consumption of the identification number setting apparatus may be prevented and a load applied to each driving control module 200 may be reduced.

Also, in this example, each driving control module 200 may transmit the determined identification number thereof according to the identification number request command from the central control module 100 as illustrated in FIGS. 5A and 5B.

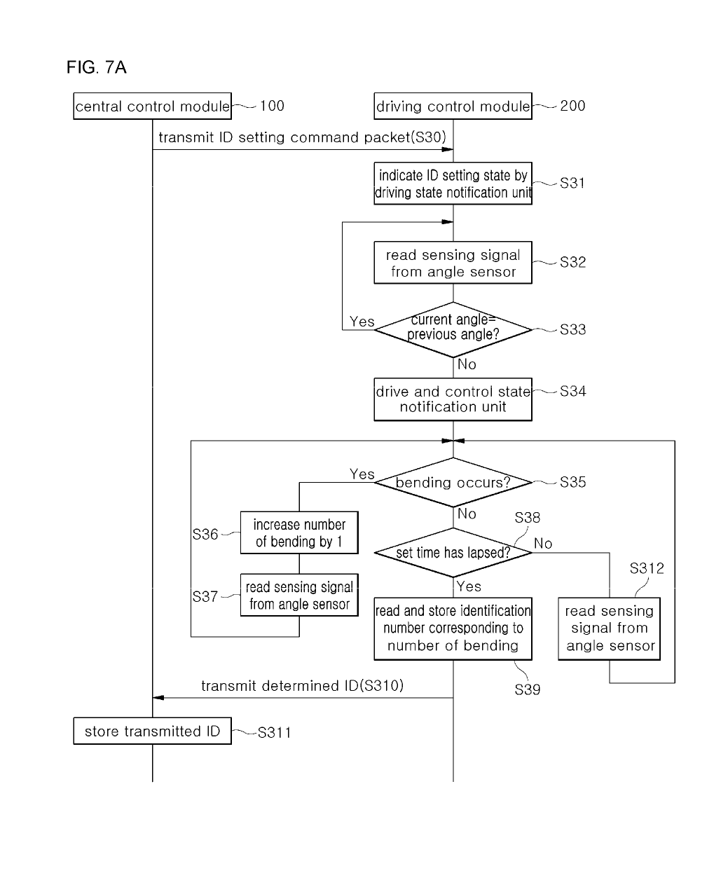

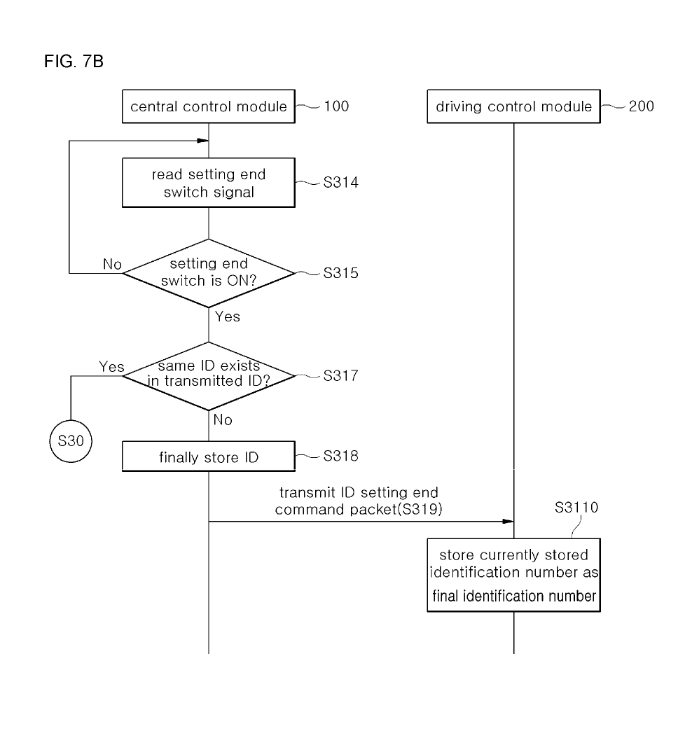

Next, another example of the identification number setting method according to an embodiment of the present invention will be described with reference to FIGS. 7A and 7B.

In the case of FIGS. 4A to 6B, a value corresponding to a rotation angle determined according to adjustment of an angle of a corresponding portion according to a user operation may be determined as an identification number of each driving control module 200.

However, in the case of FIGS. 7A and 7B, a value of the identification number may be determined according to the number of bending of the corresponding portion of the driving control module 200 may be determined. Except for the method of assigning an identification number for each driving control module 200, the method of setting an identification number illustrated in FIGS. 7A and 7B is the same as the setting method of FIGS. 4A and 4B.

Referring to FIGS. 7A and 7B, first, as described above, the operation controller 120 of the central control module 100 transmits an identification number setting command packet to all the driving control module 200 connected thereto through the bus in order to set an identification number for the plurality of driving control modules 200 initially set with the same identification number (S30).

Thus, upon receiving the identification number setting command packet, the driving controller 230 of each driving control module 200 operates the state notification unit 240 to indicate that an operation state thereof is an operation state for setting an identification number (S31).

Accordingly, the user performs an identification number setting operation for all the driving control modules 200 in which the state notification unit 240 is operated.

Therefore, the user performs a bending operation on the portion related to each driving control module 200 by a predetermined number of times. As described above, the user already knows the identification number to be given to each driving control module 200 and knows the number of times of bending operation performed according to the identification number assigned thereto.

Thus, the user performs an operation of bending a portion (e.g., wrist joint portion) related to each driving control module 200 by a predetermined number of times.

Each time the user performs the bending operation, an angular velocity regarding the driving control module 200 of the corresponding portion is changed, and the corresponding driving controller 230 determines whether the bending operation by the user has been performed using the change in the angular velocity.

In the present example, each corresponding driving controller 230 determines the number of times the corresponding portion has been bent by calculating an angular velocity by differentiating a current angle sensed by the angle sensor 211.

Therefore, the corresponding driving controller 230 of each driving control module 200 reads a sensing signal output from the angle sensor 211 to determine the current angle, and stores the determined current angle in the storage unit 260, and calculates an angular velocity using the determined angle and stores the calculated angular velocity in the storage unit 260 (S32).

Thereafter, the driving controller 230 compares the determined current angle with a previous angle to determine whether they are equal to each other (S33).

When the angle of the corresponding portion has not been changed, the driving controller 230 determines that a user operation for setting an identification number of the corresponding driving control module 200 has not been performed yet.

Accordingly, the driving controller 230 of the corresponding driving control module 200 reads a sensing signal from the angle sensor 211, while continuing to operate the state notification unit 240 (S32). Meanwhile, if it is determined that the current angle has been changed (S33), the driving controller 230 determines that the user's operation for the corresponding portion has been performed to set an identification number. Accordingly, the driving controller 230 may stop driving the state notification unit 240 (S343) and determines the number of times the user has bent the corresponding portion.

To this end, the driving controller 230 of the corresponding driving control module 200 determines whether the bending operation has been performed using the determined angular velocity (S35).

For example, if the angle has been changed from a first direction (e.g., forward direction) to a second direction (e.g., reverse direction) opposite to the first direction, or if a magnitude of the angular velocity is zero, it is determined that the bending operation was performed once.

Alternatively, it may be determined that the bending operation has been performed when angular displacement increases and then decreases or decreases and then increases with the lapse of time. This is because the angular displacement is an integral regarding time of an angular velocity.

Accordingly, when it is determined that the bending operation has been performed by the user, the driving controller 230 increases the current number of bending by 1 and stores the increased number of bending in the storage unit 260 (S36).

Thereafter, the driving controller determines an angle by reading the sensing signal from the angle sensor 211 and determines whether the corresponding portion has been bent using the angular velocity (S37, S35).

However, when it is determined in step S35 that the bending operation has not been performed on the corresponding portion, the driving controller 230 of the corresponding driving control module 200 determines that the bending operation has not been performed and subsequently determines whether a set time has elapsed (S38).

When it is determined that the set time has elapsed, the corresponding driving controller 230 determines that the user does not perform the bending operation any longer. Accordingly, the driving controller 230 determines the current number of bending stored in the storage unit 260, selects an identification number corresponding to the determined current number of bending, and stores the selected identification number as an identification number of the corresponding driving control module 200 to which the driving controller 230 belongs in the storage unit 260 to set its identification number from the initial number to the current identification number (S39).

Here, an identification number corresponding to the number of bending has already been stored in the storage unit 260 using a look-up table, or the like.

The driving controller 230 of the driving control module 200 having the determined identification number of its own transmits the determined identification number of the driving control module 200 to the central control module 100 so that the identification number may be stored in the storage unit 140 of the central control module 100 (S310, S311).

However, when the bending operation has not been performed for a predetermined set time in step S38, the driving controller 230 reads a sensing signal output from the angle sensor 211 again to determine whether the user's bending operation has been performed (S312).

When the identification number for the corresponding driving control module 200 is determined using the number of bending of the portion related to each driving control module 200 and transmitted to the central control module 100, the operation controller 120 of the central control module 100 performs the same operations as those of steps S18 to S114 of FIGS. 4A and 4B.

Accordingly, the operation controller 120 of the central control module 100 determines an operation state of the setting end switch SW1, and when the operation of the setting end switch SW1 is performed, the operation controller 120 may compare identification numbers of all the driving control modules to determine whether the same identification numbers are present. If the same identification numbers are present, the operation controller 120 transmits an identification number setting command packet to all the driving control modules 200 (S10) to perform an operation of setting identification numbers of all the driving control modules 200. If, however, the same identification numbers are not present, the operation controller 120 transmits an identification number setting end command packet to all the driving control modules 200, so that the current identification number is stored as an identification number of each of the driving control module 200 (S314 to S3110).

In the case of FIGS. 7A and 7B, the angle sensor 211 is used as a bending sensor for sensing a user's bending state.

However, the present invention is not limited thereto, and in an alternative example, any other variable factor such as an angular velocity, a voltage, a current, and the like, which is varied according to user's bending operations of the corresponding portion, and thus, a voltage sensor 212, a current sensor 213, and any other types of sensor such as an angular velocity may be used as the bending sensor for sensing the user's bending operation.

Here, the sensor for sensing a bending state such as the voltage sensor 212 and the current sensor 213 may also serve as an identification number setting operation sensor for sensing whether the user's identification number setting operation is performed.

Since the operation of setting an identification number of the driving control module 200 of each part is performed by the user's bending operation on the corresponding part, the identification number setting operation may be performed more easily and conveniently than the case of using angle adjustment.

In addition, in case where an identification number is set using fine angle adjustment, accurate angle adjustment must be performed to correspond to the identification number, and thus, there is high probability of giving the same identification number. However, since the operation of assigning an identification number assigning operation is performed using the tilt operation of the relevant portion, a probability of assigning the same identification number is low, improving operation accuracy, and thus, the identification number setting operation may be easily performed by the user.

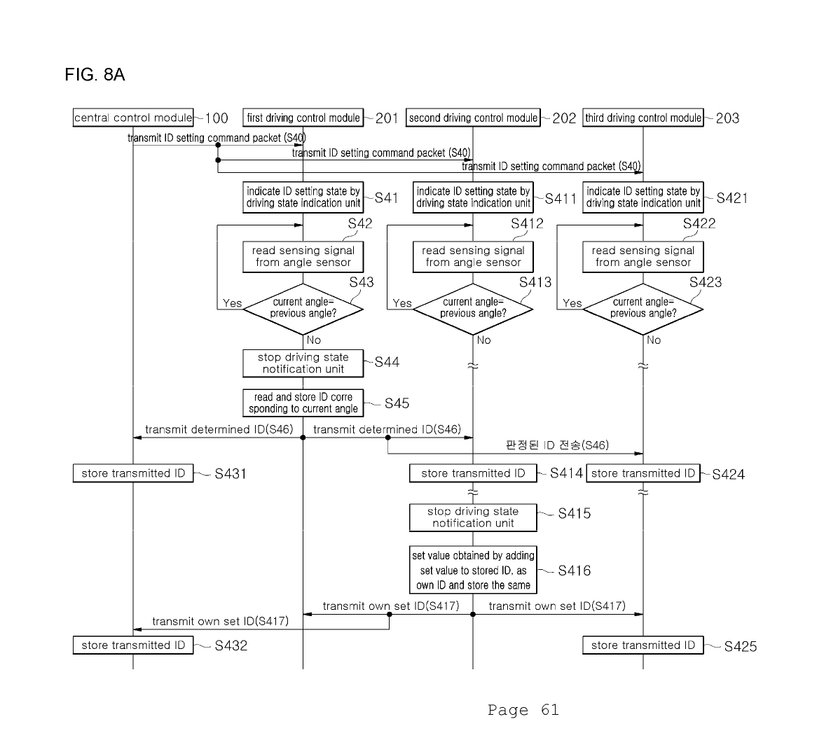

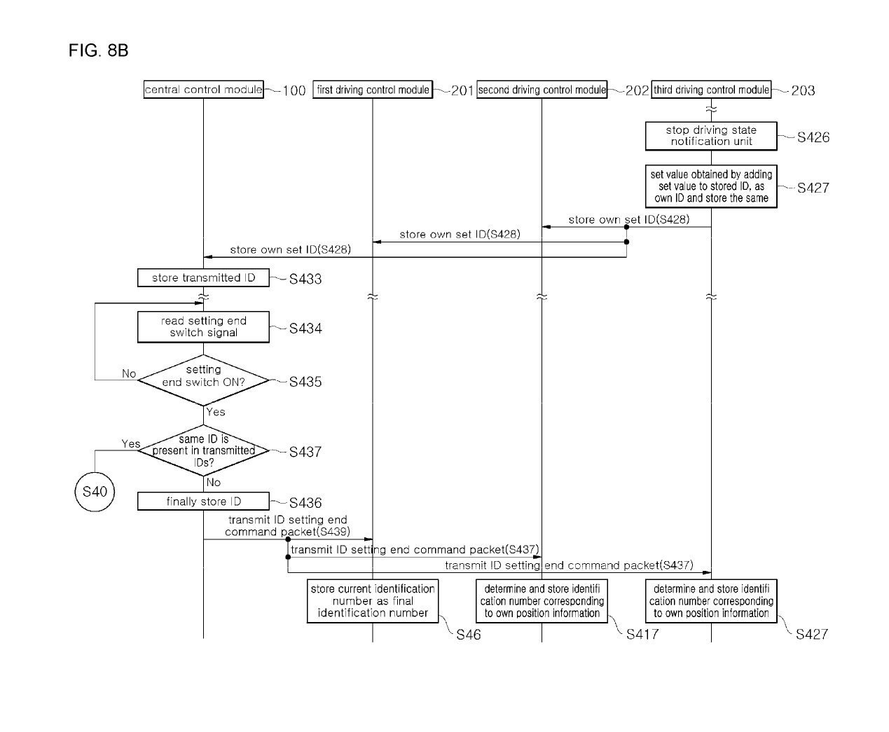

In FIGS. 8A and 8B, a method for assigning an identification number to each driving control module 200 is illustrated.

In FIGS. 4A and 4B, an identification number of the driving control module 200 is set according to angle sizes of a corresponding portion, and in the case of FIGS. 7A and 7B, an identification number of the driving control module 200 is set according to the number of times the corresponding portion is bent.

However, in the case of FIGS. 8A and 8B, the identification number of the driving control module 200 is automatically assigned to the corresponding driving control module 200 according to order in which the identification number setting operation is sequentially performed. In this case, the identification number assigned to each driving control module 200 may be a value calculated by adding a predetermined value (e.g., 1) to a previously assigned identification number.

Hereinafter, the method of setting an identification number will be described in detail with reference to FIGS. 8A and 8B.

For the purposes of description, it is assumed that one central control module 100 has three driving control modules (first to third driving control modules 201 to 203).

First, the operation controller 120 of the central control module 100 transmits an identification number setting command packet to all the driving control modules 201 to 203 through the bus (S40) to informing each of the driving control modules 201 to 203 about an identification number setting operation state, and accordingly, the driving controller 230 of each of the driving control modules 201 to 203 operates the state notification unit 240 to inform the user on the outside so that the user may perform the identification number setting operation (S41).

Accordingly, the user performs the identification number setting operation on the driving control modules 201 to 203 in which the state notification unit 240 is operated.

Here, it is assumed that the user first performs the identification number setting operation on the first driving control module 201 among the plurality of driving control modules 201 to 203.

Therefore, the user may perform the identification number setting operation on the first driving control module 201 on the first driving control module 201 according to the method described above with reference to FIGS. 4A and 4B or the method described above with reference to FIGS. 7A and 7B.

FIGS. 8A and 8B illustrate a method using angle adjustment illustrated in FIGS. 4A and 4B.

Accordingly, a portion corresponding to the driving control module 201 is moved by a corresponding angle in a corresponding direction according to the user's operation

Therefore, when the current angle of the first driving control module 201 determined using the angle sensor 211 according to the user's identification number setting operation on the first driving control module 201 is different from a previous angle, the driving controller 230 stops driving the state notification unit 240 (S42 to S44) stores an identification number corresponding to the angle determined using data stored in the storage unit 260, as its identification number again, stores the same in the storage unit 260 (S45), and subsequently transmits the set identification number (S46).

Here, the set identification number of the first driving control module 201 is also be transmitted not only to the central control module 100 but also to the remaining driving control modules 202 and 203 connected to the same bus.

The operation controller 120 of the central control module 100 stores the transmitted identification number in the storage unit 140 (S431).

Also, the other driving control modules 202 and 203 which have received identification numbers from the first driving control module 201 store the transmitted identification numbers in the storage unit 260 (S414, S424).

With this operation, the first identification number setting operation regarding the driving control module 201 is completed for the first time among the plurality of driving control modules 201 to 203.

Thereafter, the user selects one (e.g., the second driving control module 202) of the other remaining driving control modules 202 and 203 and performs the identification number setting operation thereon.

Therefore, the second driving control module 202 determines whether the user's identification number setting operation is performed on the second driving control module by comparing a current angle determined using a sensing signal from the angle sensor 211 with a previous angle, and when it is determined that the identification number setting operation is performed, the second driving control module 202 stops operating the state notification unit 240 (S412, S413, and S415).

Thereafter, the driving controller 230 of the second driving control module 202 determines an identification number of the second driving control module 202 with reference to the identification number currently stored in the storage unit 260, i.e., the most recently stored identification number of the first driving control module 201.

To this end, in this example, the driving controller 230 of the second driving control module 202 determines a vale calculated by adding a set value such as to the identification number of the first driving control module 201 stored in step S414, the most recently stored identification number, as its identification number and stores the same as its identification number in the storage unit 260 (S416).

Thereafter, the driving controller of the second driving control module 202 transmits the determined identification number thereof to other driving control modules 201 and 203 different from the central control module 100 through the bus (S417).

Accordingly, the central control module 100 stores the transmitted identification number in the storage unit 140 (S432).

However, the first and third driving control modules 201 and 203, other driving control modules, determine whether to store the transmitted identification number according to whether the identification number setting operation by the user has been performed. Here, the driving controller 230 determines whether the user's identification number setting operation has been performed on the corresponding driving control module 201 to 203 using a value of a state flag indicating whether the identification number setting operation has been performed by the user.

Therefore, the driving control module (e.g., the first driving control module 201) on which the identification number setting operation by the user has been completed through the operation described above does not store the identification number transmitted from the second driving control module 202.

Meanwhile, the driving control module (e.g., the second driving control module 203), on which the identification number setting operation by the user has not been performed, stores the identification number transmitted from the second driving control module 202 (S425).

Accordingly, the identification number of the second driving control module 202 on which the identification number setting operation has been performed secondly is determined through this process.

An operation of the remaining third driving control module 203 is also performed in the same manner as the operation of the second driving control module 202, and the third driving control module 203 determines its identification number and store the same.

That is, if it is determined that the identification number setting operation by the user is performed, the third driving control module 203 stops the operation of the state notification unit 240, adds a set value to the identification number currently stored in the current storage unit 260 and determines it as its identification number (S426, S427).

Thereafter, the third driving control module 203 transmits the determined identification number thereof to the central control module 100 and the other remaining driving control modules 201 and 202 (S428).

Accordingly, the central control module 100 stores the transmitted identification number in the storage unit 140 (S433). However, since the remaining driving control modules 201 and 202 have already completed its identification number setting operation, the driving control modules 201 and 202 do not store the identification number of the third driving control module and disregard it.

As described above, the driving control module 201, in which the identification number is first set, determines the identification number by a value determined by the identification number setting operation (for example, the first setting operation) by the user, and the other remaining driving control modules 202 and 203 on which the identification number setting operation is sequentially performed set values which are not the same as the identification number of the other driving control module 201 previously received through the bus, as their identification numbers by the user's identification number setting operation (e.g., the second setting operation) sequentially input to the other remaining driving control modules 202 and 203.

In this case, the sequentially determined identification numbers may be values obtained by adding the set value to the identification numbers of the other driving control modules determined in the immediately preceding step. Therefore, an operation load on each of the driving control modules 201 to 203 may be reduced and a probability that the same identification number is assigned to a plurality of driving control modules may be significantly reduced, significantly enhancing accuracy of the identification number setting operation. In addition, the user's operation to be performed for setting the identification numbers may be reduced, significantly enhancing user convenience.

When the identification number setting operation regarding all the driving control modules 201 to 203 is completed in this manner, the central control module 100 determines whether the same identification number is present using an operation state of the setting end switch SW1 in the same manner as described above. When identification numbers are repeated due to the presence of the same identification number, the central control module 100 may perform the operation of setting an identification number of the driving control module 100 again. When the overlap identification number is not present, the central control module 100 transmits an identification number setting command packet to the driving control modules 201 to 203 so that the current identification number may be stored as a final identification number (S434 to S439, S46, S417, S429).

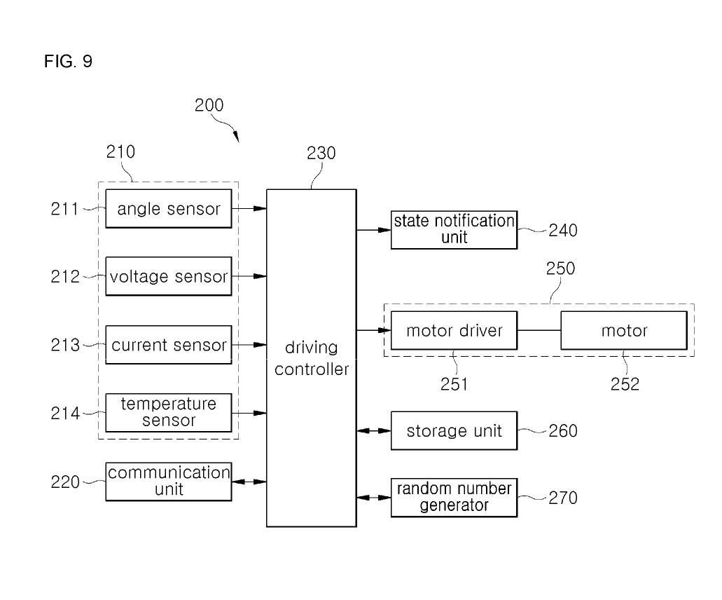

In an alternative example, as illustrated in FIG. 9, the driving control module 200 may include a random number generator 270 connected to the driving controller 230 and operated under the control of the driving controller 230 to generate a random number. In this case, when the identification number setting operation is sequentially performed after the driving control module 201 for which the identification number was first determined, the random number generator 270 may generate random numbers using an immediately determined identification number as a seed value for a random number generation operation of the random number generator 270, instead of a set value, and the generated random numbers may be set as identification numbers of the corresponding driving control modules. Accordingly, the driving controller 230 of each of the corresponding driving control modules 202 and 203 may stop operation of the state notification unit 240, inputs the immediately previously determined identification number stored in the storage unit 260, as a seed value, to the random number generator 270 to generate a random number, and read the generated random number to determine its identification number.

Thus, when the identification number is determined using the random number, the user may not know the determined identification number. Thus, the operation controller 120 of the central control module 200 may output the identification number transmitted to the information output unit 130 and notify the identification number determined for the corresponding driving control module 200 to the user.

In another example, the driving control modules 202 and 203 may determine one identification number, for example, the identification number of the first driving control module 201 for which the identification number was first determined, among the plurality of driving control modules, as a reference identification number (i.e., reference value) and determine random numbers generated using the reference identification number as a seed value of the random number generator 270, as identification numbers of the driving control modules 202 and 203, instead of the immediately previously generated identification number.

To this end, the driving control modules 202 and 203 store the identification numbers transmitted first after transmitting the identification number setting command packet, as the reference identification number, and thereafter, when it is determined that the user's identification number setting operation is performed on the driving control modules 202 and 203, the driving control modules 202 and 203 stop driving of the state driving unit 240. Thereafter, the driving control modules 202 and 203 read random numbers generated by inputting the reference identification number as a seed value to the random number generator 270 to operate it, as their identification numbers. In this case, the driving control modules 202 and 203 do not store identification numbers transmitted from other driving control modules 202 and 203 after the reference identification number.

In another alternative example, when each driving control module 200 includes the random number generator 270, the driving control module 200 may determine an identification number of the corresponding driving controller 200 using a random number generated by the random number generator 170, as well as an angle of a corresponding portion or the number of bending.

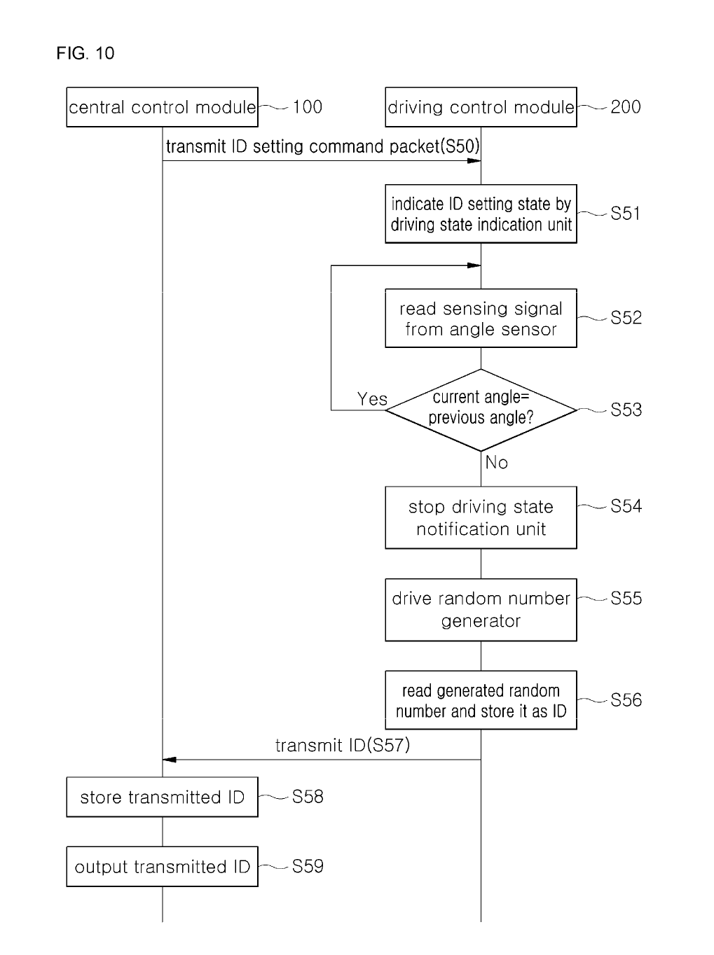

That is, as illustrated in FIG. 10, as described above with reference to FIG. 4A, after the identification number setting command packet is transmitted from the operation controller 120 of the central control module 100 (S50), it is determined that the user identification number setting operation is performed on the corresponding driving control module 200 using an angle sensor or a touch sensor, and when an identification number according to the user's identification number setting operation is determined using a stored value of the storage unit 260, the operation of the state notification unit 240 is stopped (S51 to S54), and thereafter, the driving controller 230 of the driving control module 200 generates a random number by operating the random number generator by inputting a predetermined identification number as a seed value to operate the random number generator 270, reads the generated random number, and stores the same as its identification number (S55, S56).

Thereafter, the driving controller 230 transmits the determined identification number to the central control module 100 (S57) so that the determined identification number may be stored as an identification number (S58).

Thereafter, the operation controller 120 of the central control module 100 outputs the identification number determined through the information output unit 130 so that the user may know the determined identification number (S59).

The operation for determining whether overlap identification numbers are present, which is a subsequent operation, is the same as that described above and is therefore omitted.

In this case, it is not necessary to previously set a separate identification number corresponding to an operation state of the user, and the storage unit 260 of the driving control module 200 does not need to store the identification number corresponding to the operation state of the user. In the case of the examples described above, according to the method described above with reference to FIGS. 5A, 5B, 6A, and 6B, each driving control module 200 may transmit a determined identification number to the central control module 100 according to a corresponding request from the central control module 100, and when identification numbers are repeated, the identification number setting operation may be performed only on the driving control module 200 having the overlap identification number.

In the identification number setting apparatus according to the present invention, as the method of setting an identification number of the driving control module 200, after the state notification unit 240 is operated using the touch sensor, an identification number regarding the driving control module 200 may be determined on the basis of the number of touches applied to a corresponding portion after the state notification unit 240 is operated using the touch sensor or an identification number of the driving control module 200 may be determined according to a movement speed of the corresponding portion, rather than using one of methods of setting an identification number using an angle size, the number of bending, an initial identification number, and a random number.

Here, since the touch sensor, or the like, is for sensing the user's operation to set an identification number, the touch sensor also serves as an identification number setting operation sensor, like the angle sensor.

Although the embodiment of the present invention regarding the case where the motor in the driving control module 200 performs a rotational motion has been described, the motor as a driver in the driving control module 200 is not limited only to the motor that performs the rotational motion.

That is, the present invention may also be applied to a case where the driver in the driving control module is a driver which performs a linear motion, e.g., a linear motor. In this case, the “angular displacement” and “angular velocity” in the embodiments described above should be interpreted as “displacement” and “velocity”, respectively. Also, the “rotational direction” should be interpreted as a “movement direction”. Also, in this case, the sensor for sensing an operation state of the driver which performs a linear motion is a position sensor which senses a position, like a movement distance sensor, and in this case, the position sensor serves as an identification number setting operation sensor.

While the present invention has been shown and described in connection with the embodiments, it will be apparent to those skilled in the art that modifications and variations may be made without departing from the spirit and scope of the invention as defined by the appended claims.

1. A slave device comprising:
an identification number setting operation sensor sensing a user's operation for performing an identification number setting operation on the slave device;
a slave controller connected to the identification number setting operation sensor; and
a storage unit connected to the slave controller and storing an identification number corresponding to a state range,
wherein, when an identification number setting command packet is transmitted from a master device, the slave controller determines a state determined according to the user's identification number setting operation using a signal from the identification number setting operation sensor and determines an identification number corresponding to the state in the storage unit, as an identification number of the slave device.

2. The slave device of claim 1, wherein
the identification number setting operation sensor is an angle sensor sensing an angle of the slave device according to the user's identification number setting operation, and
the slave controller selects an identification number in the storage unit using a sensing signal output from the angle sensor and determines the selected identification number as an identification number of the slave device.

3. The slave device of claim 1, wherein
the identification number setting operation sensor is a bending sensor sensing a bending state of the slave device according to the user's identification number setting operation, and
the slave controller selects an identification number in the storage unit using a sensing signal output from the bending sensor and determines the selected identification number as an identification number of the slave device.

4. The slave device of claim 1, wherein
the identification number setting operation sensor is a position sensor sensing a bending state of the slave device according to the user's identification number setting operation, and
the slave controller selects an identification number in the storage unit using a sensing signal output from the position sensor and determines the selected identification number as an identification number of the slave device.

5. The slave device of claim 1, further comprising:
a random number generator connected to the slave controller,
wherein the slave controller determines a random number generated by the random number generator using the identification number setting operation sensor, as an identification number of the slave device.

6. The slave device of claim 1, further comprising:
a state notification unit connected to the slave controller and operated by the slave controller when the identification number setting command packet is transmitted.

7. An identification number setting apparatus including a master device and a plurality of slave devices connected to a bus according to a multi-drop communication scheme,
wherein when the master device transmits an identification number setting command packet to the plurality of slave devices, a slave device in which an identification number is first set sets an identification number according to a first setting operation and transmits the set identification number to the bus, and
the other remaining slave devices, excluding the slave device which has first transmitted the identification number, among the plurality of slave devices, each set a value, which does not overlap identification numbers of the other slave devices previously received through the bus, as its identification number according to second setting operations sequentially input to the other remaining slave devices, and transmit the set identification number to the bus.

8. The identification number setting apparatus of claim 7, wherein
the other remaining slave devices, excluding the slave device which has first transmitted the identification number, among the plurality of slave devices, each set a result value obtained by adding a predetermined value to an identification number of a slave device which has set the identification number immediately previously according to second setting operations sequentially input to the other remaining slave devices, as its identification number, and transmit the set identification number to the bus.
